(19) United States
(12) Patent Application Publication
(10) Pub. No.: US 2008/0195976 A1
(43) Pub. Date: Aug. 14, 2008

(54) METHOD OF SETTING PASSWORD AND METHOD OF AUTHENTICATING PASSWORD IN PORTABLE DEVICE HAVING SMALL NUMBER OF OPERATION BUTTONS

(76) Inventors: Kyung-suk Cho, Suwon-si (KR); Jong-hyun Lee, Hwasoong-si (KR); Fung-chan Kim, Anyang-si (KR)

Correspondence Address: STEIN, MCEWEN & BUI, LLP, 1400 EYE STREET, NW, SUITE 300, WASHINGTON, DC, 20005, US

(21) Appl. No.: 11/942,972

(22) Filed: Nov. 20, 2007

(30) Foreign Application Priority Data
Feb. 14, 2007 (KR) 2007-15528

(51) Int. Cl. G06F 3/048; G06F 7/04

(52) U.S. Cl. 715/840; 726/5

(57) ABSTRACT

A method of setting a password and a method of authenticating a password in a portable device having a small number of operation buttons. The method of setting a password includes: determining whether there is an input through the operating of an operation button within a predetermined time; displaying a symbol of the operated operation button, when there is an input through the operating of an operation button within the predetermined time; and setting displayed symbols as a password required for using the portable device, when there is an input through the operating of an operation button for representing an end of an input of symbols. Accordingly, the password can be set by operating operation buttons in the portable device having no text or number buttons. Authentication of a password can be performed by using the set password.

### CROSS-REFERENCE TO RELATED APPLICATION

This application claims the benefit of Korean Patent Application No. 2007-15528, filed in the Korean Intellectual Property Office on Feb. 14, 2007, the disclosure of which is incorporated herein by reference.

### BACKGROUND OF THE INVENTION

1. Field of the Invention

Aspects of the present invention relate to a method of setting a password and a method of authenticating the password by using a small number of operation buttons so as to protect information on a device such as a MP3 player, a mobile phone, handheld games console and the like, which have a small number of buttons.

2. Description of the Related Art

Conventional electronic devices generally include a plurality of keys, including number keys. A user can set a password and perform an authentication process using the number keys. New portable devices, such as MP3 players, mobile phones, games, and the like, have only a small number of buttons, and may not have number keys, due to a desire to reduce the size of portable devices.

In order to set passwords for these devices, a window having icons representing numbers is displayed. The password is set by pressing the buttons and selecting numbers needed for setting the password on the displayed window. In addition, in order to authenticate a password, the window having icons representing numbers and/or letters needed for inputting a password is displayed again. The password is authenticated by pressing the buttons on the device, selecting numbers needed for authenticating the password on the displayed window, and determining whether the selected numbers match the previously set password. However, if a password is set or a password is authenticated using the conventional method, the buttons have to be manipulated in a complex manner by, for example, pressing up, down, left, and/or right buttons many times.

An aspect of the present invention is to provide a method of setting a password and a method of authenticating a password through simple manipulations of buttons on the device.

### SUMMARY OF THE INVENTION

Aspects of the present invention provide a method of setting a password and a method of authenticating a password in a portable device having a small number of buttons capable of setting the password and authenticating the password by using the set password using only the small number of buttons included in the portable device.

According to an aspect of the present invention, a method of setting a password in a portable device having a small number of buttons is provided. The method comprises determining whether one of the buttons, other than a button corresponding to a number or letter, is pressed within a predetermined time; displaying a symbol corresponding to the pressed button, each time a button is pressed within the predetermined time; and setting displayed symbols corresponding to the pressed button as a password required for using the portable device.

According to another aspect of the present invention, a method of authenticating a password in a portable device having a small number of buttons is provided. The method comprises determining whether a one of the buttons, other than a button corresponding to a number or letter, is pressed within a predetermined time; displaying a symbol corresponding to the button, each time a valid button is pressed within the predetermined time; determining whether displayed symbols match a previously set password, when one of the pressed buttons represents an end of an input of symbols; and authenticating the password required for using the portable device, if the displayed symbols match the previously set password.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an MP3 player as an example of a portable device according to an embodiment of the present invention;

FIG. 2 is a flowchart illustrating a method of setting a password in a portable device with a small number of operation buttons according to an embodiment of the present invention;

FIG. 3 is a flowchart illustrating a method of setting a password in a portable device with a small number of operation buttons according to another embodiment of the present invention;

FIG. 4 illustrates a table showing information on uses of operation buttons in a general mode, a password setting mode, and an authentication mode;

FIG. 5 illustrates information on whether the operation buttons shown in FIG. 4 are valid for setting a password and authenticating a password as a table;

FIG. 6 is a flowchart illustrating a method of authenticating a password in a portable device with a small number of operation buttons according to an embodiment of the present invention; and

FIG. 7 is a flowchart illustrating a method of authenticating a password in a portable device with a small number of operation buttons according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

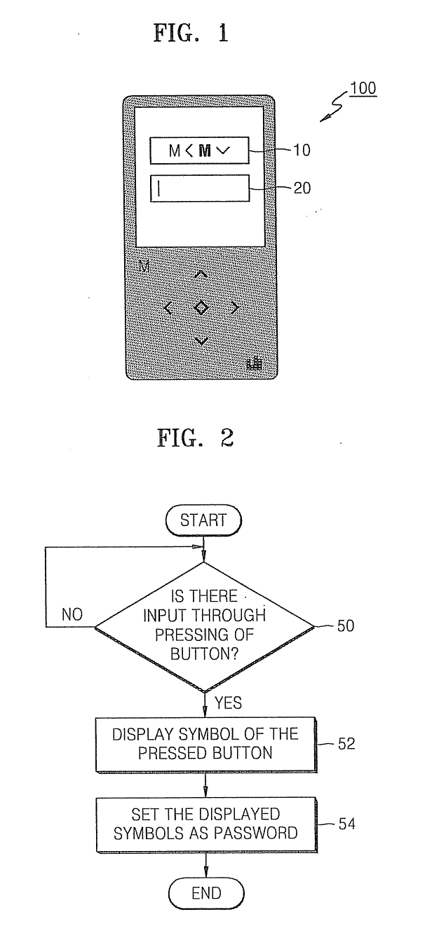

FIG. 1 illustrates a portable device 100 according to an embodiment of the present invention. The portable device 100 shown in FIG. 1 is an MP3 player and has no number keys. The MP3 player includes only a small number of buttons for operating the MP3 player. As shown in FIG. 1, the MP3 player includes only buttons M, <, >, [symbol] , [symbol] , and ⋄. Despite having so few buttons, a password can be set, and an authentication procedure can be performed, in a simple manner in the portable device having few buttons. The portable device 100 may be, for example, a mobile phone, a personal digital assistant, a personal entertainment device, or the like. The buttons shown in FIG. 1 are merely exemplary; a portable device according to aspects of the invention may have any number of buttons arranged or identified in any manner. For example, a personal entertainment device may have buttons labeled “A” and “B” in addition to directional buttons up, down, left, and right. Similarly, according to other aspects of the invention, the portable device may include input mechanisms other than buttons, such as a sliding bar, scroll wheel, scroll ball, switch, or the like. The term “button”, as used herein, also includes these input mechanisms. Similarly, “pressing” includes any manipulation of an input mechanism, such as sliding, scrolling, or the like.

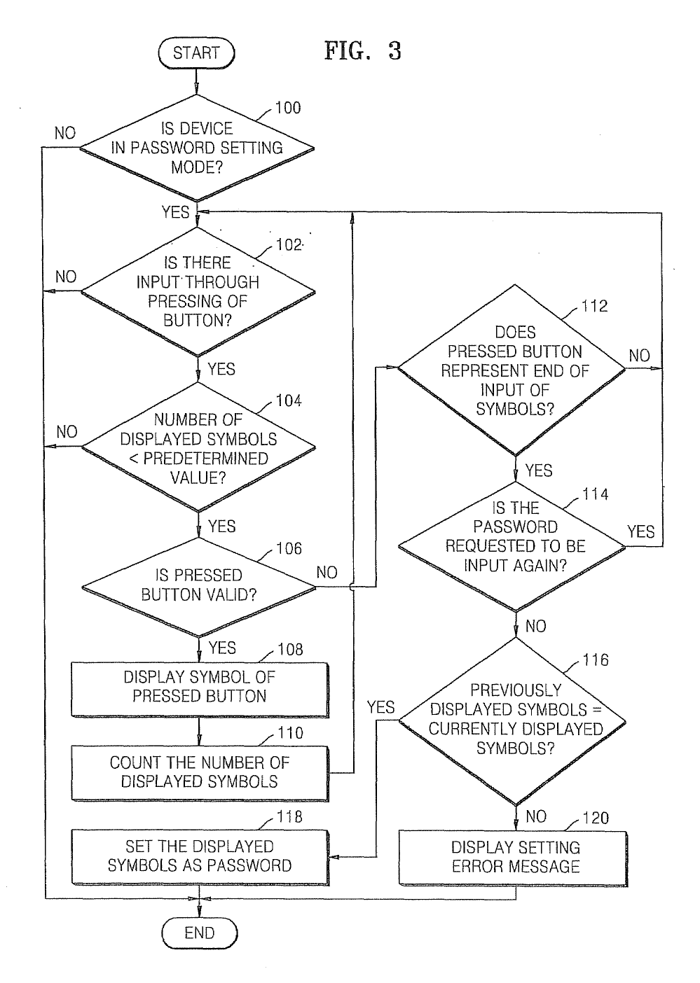

FIG. 2 is a flowchart illustrating a procedure of setting a password in the portable device 100 having a small number of buttons according to an embodiment of the present invention. First, whether a button is pressed within a predetermined time is determined at operation 50. The predetermined time may be arbitrarily determined by a manufacturer or user. For example, the predetermined time may range from 1 to 3 seconds. Although an MP3 player is exemplified in FIG. 1, all the buttons of the portable device 100 can be used to set a password instead of text or number buttons. That is, as a combination of letters and numbers may be used to set a password for a mobile phone, PDA, or PC, so may a combination of operation buttons (such as a reproduction button; a menu button; up, down, left, and right buttons; and a stop button) be used to set a password in a portable device having fewer buttons according to aspects of the present invention. In addition, the number of combinations of symbols may be increased by distinguishing a long press operation from a short press operation of the buttons. Cases where the buttons M, <, >, [symbol] , [symbol] , and ⋄ shown in FIG. 1 are pressed for a long time are recognized differently from cases where the buttons are pressed for a short time. For example, a case where a button is pressed for a period less than 100 msec may be recognized as a short press operation of the button. A case where the button is pressed for a period equal to or greater than 100 msec may be recognized as a long press operation of the button.

If there is an input through the operation of an operation button within a predetermined time, a symbol corresponding to the button is displayed at operation 52. For example, if the buttons M, <, >, [symbol] , [symbol] and ⋄ shown in FIG. 1 are pressed, the corresponding symbols, i.e., M, <, >, [symbol] , [symbol] , and ⋄, are displayed on a first display window 10 of the portable device. In order to distinguish long press operations from short press operations, when the buttons are pressed for a long time, the symbols M, <, >, [symbol] , [symbol] , and ⋄ may be displayed differently, such as in a different font or in an underlined, outlined, or bold-faced form, or the like.

If a button representing an end of the input of symbols is pressed, the displayed symbols are set as a password required for using the portable device at operation 54. For example, if a button representing an end of the input of symbols is ⋄, if the button ⋄ is input, the symbols input and displayed before the input of the button ⋄ are set as the password required for using the portable device. If a combination of displayed symbols is “M<M(bold) [symbol] ”, the combination of symbols “M<M(bold) [symbol] ” is set as a password required for using the MP3 player.

FIG. 3 is a flowchart illustrating a procedure of setting a password in the portable device 100 according to another embodiment of the present invention. First, whether the portable device 100 is in a password setting mode is determined at operation 100. Modes of the portable device 100 include a password setting mode, a password authentication mode, and a general mode. In the general mode, general functions of the portable device 100, such as reproduction of music, reproduction of a photograph, reproduction of a moving picture, reproduction of games, a searching function, and a setting menu, are performed.

In the password setting mode, the user sets a password through the menu, when the user desires to set the password for a predetermined function, such as booting, reproduction of a photograph, reproduction of music, or the link. In the password authentication mode, the user is authenticated by inputting the password that was set in the password setting mode. If the portable device is in the password setting mode, whether there is an input through the pressing of the button within a predetermined time is determined at operation 102. The predetermined time may be arbitrarily determined by a manufacturer or user.

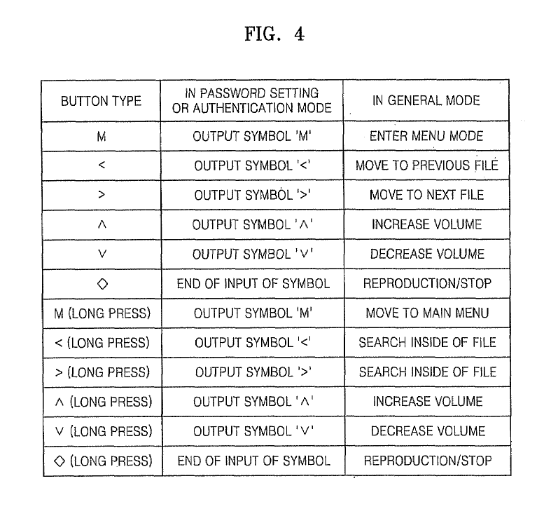

FIG. 4 illustrates a table showing information on uses of buttons in a general mode, a password setting mode, and an authentication mode. As shown in FIG. 4, the operation buttons M, <, >, [symbol] , [symbol] , and ⋄ serve to perform various functions, such as movement from the general mode to the menu mode, movement to the previous file, movement to the next file, increase of the volume, decrease of the volume, reproduction/stop, and the like. In the password setting and authentication mode, the operation buttons M, <, >, [symbol] , [symbol] , and ⋄ function as symbols for forming a password.

The number of possible combinations of symbols can be increased by distinguishing the long press operation from the short press operation of the buttons. Cases where the buttons M, <, >, [symbol] , [symbol] , and ⋄ shown in FIGS. 1 and 4 are pressed for a long time are recognized differently from cases where the buttons are pressed for a short time.

If a button is pressed within a predetermined time, whether the number of displayed symbols is less than a predetermined value is determined at operation 104. The predetermined value indicates an upper limit of the number of symbols that can be included in the password. For example, as shown in FIG. 1, in operation 104, it is determined whether the number of displayed symbols “M<M(bold) [symbol] ” is less than the predetermined value for representing that the upper limit of the number of symbols. Specifically, if the predetermined value is six, since the number of the displayed symbols in FIG. 1 is four, it is determined that the number of the display symbols is less than the predetermined value. If the number of the displayed symbols is less than the predetermined value, whether the operation button is valid for use in a password is determined at operation 106. Whether the button is valid for use in a password may be based on whether there is index information corresponding to the buttons for use in the password.

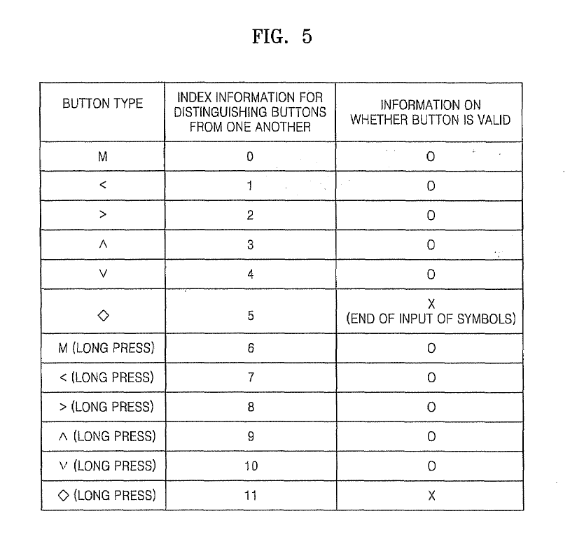

FIG. 5 illustrates a table indicating whether the buttons shown in FIG. 4 are valid for setting a password and authenticating a password. As shown in FIG. 5, the index information distinguishing the buttons from one another is stored in the portable device 100 as a table. For example, if the index information is 0 to 4 and 6 to 10, the operation button corresponding to the index information is valid for use in the password. However, if the index information is 5 or 11, the button corresponding to the index information is invalid for use in the password.

If the operation button is valid for use in the password, the symbol of the button is displayed at operation 108. For example, if the button M is pushed and corresponding input is received, since the index information of the button M is 0 in FIG. 5, the button M is valid for use in the password. Accordingly, the symbol corresponding to the button M is displayed on the first display window 10 of FIG. 1. The number of the displayed symbols is counted at operation 110. For example, in order to set the password, the number of the symbols displayed on the first display window 10 of FIG. 1 is counted. The counted number of the displayed symbols is compared with the predetermined value in operation 104.

If the button pressed is invalid for use in the password, whether the button represents an end of input of symbols is determined at operation 112. The button representing the end of the input of symbols indicates that there are no more symbols to be input for use in the password. For example, when there is an input through the operation of the button ⋄, since the index information of the button ⋄ corresponds to 5 in FIG. 5, the button is not a valid button for use in a password, but functions as a button representing the end of the input of the symbols. If the button is not the button representing the end of the input of symbols, the procedure proceeds to operation 102 and the aforementioned operations are repeated.

If the pressed button is the button representing the end of the input of symbols, whether the password is requested to be input again is determined at operation 114. The password is requested to be input again by manipulating the buttons corresponding to the displayed symbols, so that the user can confirm the password setting information by re-inputting the same password when setting the password. When the password is requested to be input again by pressing the buttons, the procedure returns to operation 102, and the operations of pressing the buttons for setting the password and displaying the symbols are repeated. The re-input symbols of the buttons are displayed on a second display window 20 of FIG. 1. Since operation 114 is a dispensable step of the invention, operation 114 may be omitted.

If the password is not requested to be input again by pressing the buttons, whether the currently displayed symbols match the previously displayed symbols is determined at operation 116. Since operations 114 to 116 are dispensable steps, operations 114 to 116 may be omitted. Accordingly, after operation 112, the procedure may proceed to operation 118.

If the previously displayed symbols match the currently displayed symbols, the displayed symbols are set as a password required for using the portable device at operation 118. For example, if the symbols displayed on the first display window 10 of FIG. 1 match the symbols displayed on the second display window 20, since the user has correctly input the symbols, the symbols are set as the password required for using the portable device.

If the symbols displayed on the first display window 10 of FIG. 1 do not match the symbols displayed on the second display window 20, a setting error message indicating that the setting of the password has failed is displayed at operation 120. For example, if the symbols displayed on the first display window 10 of FIG. 1 do not match the symbols displayed on the second display window 20, since the user has input the symbols incorrectly, a setting error message is displayed, reporting to the user that the setting of the password has failed.

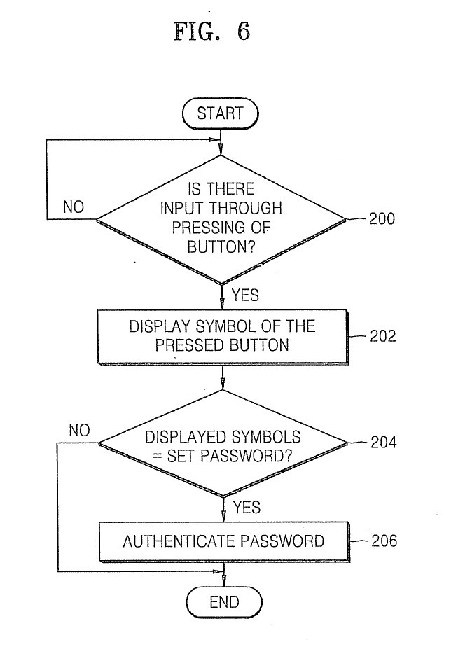

A procedure of authenticating a password in a portable device with a small number of buttons according to an embodiment of the present invention will be described with reference to the attached drawings. FIG. 6 is a flowchart illustrating a procedure of authenticating a password in a portable device having a small number of buttons according to an embodiment of the present invention.

First, whether there is an input through the pressing of a button within a predetermined time is determined at operation 200. The predetermined time may be arbitrarily determined by a manufacturer or user. The number of combinations of symbols may be increased by distinguishing a long press of the buttons from a short press of the buttons. Cases where the buttons M, <, >, [symbol] , [symbol] , and ⋄ shown in FIGS. 1 and 4 are pressed for a long time are recognized differently from cases where the buttons are pressed for a short time.

If there is an input through the pressing of the buttons within a predetermined time, the symbol of the corresponding button is displayed at operation 202. For example, if the buttons M, <, >, [symbol] , [symbol] , and ⋄ shown in FIG. 1 are pressed, the symbols corresponding to the buttons are displayed. In order to distinguish long press operations from short press operations, when the operation buttons are pressed for a long time, the symbols M, <, >, [symbol] , [symbol] , and ⋄ are displayed differently, such as in a different font or in an underlined, outlined, or bold-faced form, or the like.

If a button representing an end of an input of symbols is pressed, the displayed symbols are matched with the previously set password at operation 204. For example, in a case where a button representing an end of the input of symbols is ⋄, if the button ⋄ is pressed, the symbols input and displayed before the input of the button ⋄ are compared with the previously set and stored password.

If the displayed symbols match the previously set password, the password required for using the portable device is authenticated at operation 206. For example, if the set password is “M<M(bold) [symbol] ” and the password displayed in the procedure of authenticating a password is also “M<M(bold) [symbol] ”, the symbols of the two passwords match, and the password is authenticated. However, if the displayed symbols do not match the previously set password, the user is informed that the password has not been authenticated.

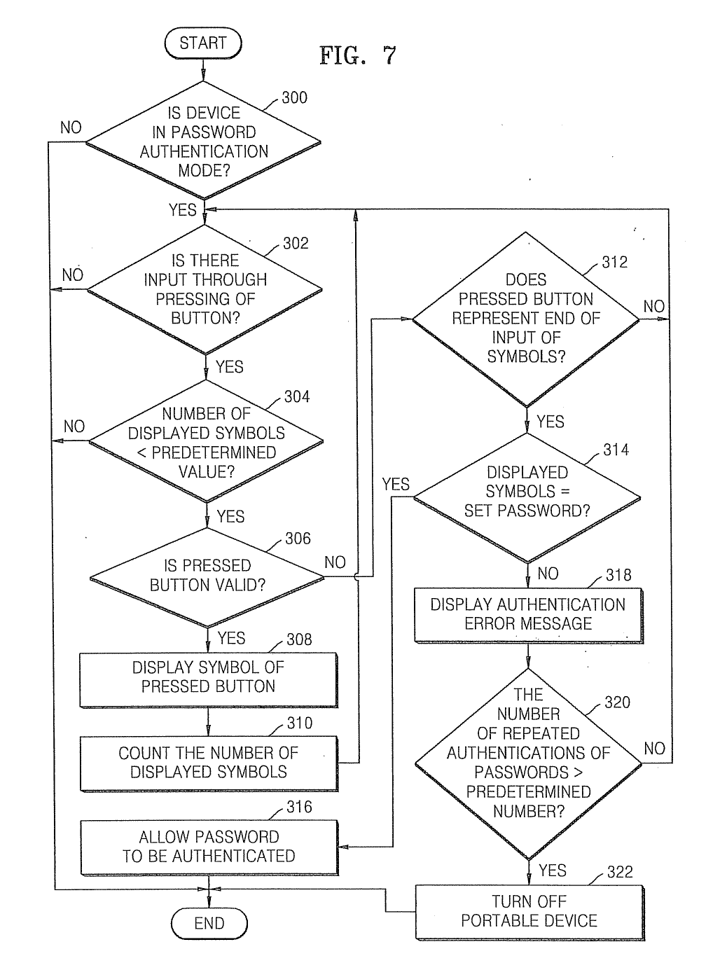

FIG. 7 is a flowchart illustrating a procedure of authenticating a password in a portable device having a small number of buttons according to another embodiment of the present invention. First, whether the portable device is in a password authentication mode is determined at operation 300. In the password authentication mode, it is determined whether the user is authorized to use the device by using the password that was set in the password setting mode.

If the portable device is in the password authentication mode, whether a button has been pressed within a predetermined time is determined at operation 302. The number of combinations of symbols may be increased by distinguishing the long press of the button from the short press of the buttons. Cases where the buttons M, <, >, [symbol] , [symbol] , and ⋄ shown in FIGS. 1 and 4 are pressed for a long time are recognized differently from cases where the buttons are pressed for a short time.

If there is an input through the pressing of the buttons within a predetermined time, whether the number of displayed symbols is less than a predetermined value is determined at operation 304. The predetermined value indicates an upper limit of the number of symbols that may be included in the password.

If the number of the displayed symbols is less than the predetermined value, whether the operation button is valid for authenticating a password is determined at operation 306. Whether the button is valid for use in a password is determined based the presence of index information corresponding to the buttons valid for use in the password. As shown in FIG. 5, the index information for distinguishing the buttons from one another is previously stored in the portable device as a table. For example, if the index information is 0 to 4 and 6 to 10, the button corresponding to the index information is valid for use in the password. Other aspects of the invention may include different formats or arrangements of the index information, or may store a correspondence between the symbols and the buttons in another way.

If the button is valid for use in the password, the symbol of the operation button is displayed at operation 308. For example, if there is an input through the pressing of a button M, since the index information of the operation button M is 0 in FIG. 5, the button M is valid for use in the password. Accordingly, the symbol of the operation button M is displayed on the first display window 10 of FIG. 1.

The number of the displayed symbols is counted at operation 310. For example, in order to set the password, the number of the symbols displayed on the first display window 10 of FIG. 1 is counted. The counted number of the displayed symbols is compared with the predetermined value in operation 304.

Alternatively, if the button is invalid for use in the password, whether the button represents an end of an input of symbols is determined at operation 312. The button representing the end of the input of symbols indicates that there is no further input for use in the password. For example, if the button ⋄ is pressed, since the index information of the button ⋄ is 5, as shown in FIG. 5, the button is not a valid button for use in a password, but functions as a button representing the end of the input of the symbols. If the button does not represent the end of the input of symbols, the procedure returns to operation 302 and repeats the aforementioned operations.

If the button represents the end of the input of symbols, the displayed symbols are matched with the previously set password at operation 314. For example, as shown in FIG. 5, if the is an input through the pressing of the button ⋄ representing an end of an input of symbols, the symbols that are displayed and that are input before the input of the button ⋄, are matched with the previously set and stored password.

If the displayed symbols match the previously set password, the password required for using the portable device is authenticated at operation 316. Since the password that is set in the procedure of setting a password matches the password displayed in the procedure of authenticating a password, the password is authenticated. However, if the displayed symbols do not match the previously set password, an authentication error message representing that the authentication of the password has failed is displayed at operation 318.

Whether the number of repeated authentications of passwords exceeds a predetermined number is determined at operation 320. For example, when an upper limit of the number of authentication attempts is three, it is determined whether the number of currently repeated authentications of the passwords exceeds three. If the number of repeated authentications of passwords does not exceed the predetermined number, the procedure returns to operation 302 and repeats the aforementioned password authentication procedure.

If the number of authentication attempts exceeds the predetermined number, power to the portable device is turned off at operation 322. When the number of repeated authentications of passwords exceeds the predetermined number, since it is determined that a non-authorized user performs the authentication procedure so as to use the portable device, power to the portable device is turned off so as to limit the use of the portable device. According to other aspects of the invention, the portable device may be deactivated in other ways, such as by displaying a message to the user prior to turning off, or by entering a sleep mode or other low-power mode instead of turning off.

The portable device 100 according to another embodiment of the invention may include the plurality of buttons, a display to display the symbols corresponding to the plurality of buttons, a controller, and a storage unit. The storage unit stores the index information and the password. The controller controls operation of the portable device 100 so as to set or authenticate a password. The controller may perform any or all of the operations described above with respect to FIGS. 2, 3, 6, and 7.

The pressing of the buttons may be interpreted as a sequence of button presses. This sequence may in turn be interpreted as a corresponding sequence of symbols. The correspondence between a button and a symbol may be defined in the index information shown in FIGS. 4 and 5. As described above, the duration of the pressing of the button may also be used to determine the corresponding symbol. For example, as shown in FIG. 5, a short press (short duration) of the button “M” is assigned the index value “0”, while a long press (long duration) of the button “M” is assigned the index value “6”. The end of a sequence of symbols may be determined based on an end of input of symbols button, as described above.

Password setting and authentication procedures according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

In the method of setting a password and the method of authenticating a password in the portable device having a small number of buttons, the password may be set by using the buttons included in the portable device instead of or in addition to text or number buttons, and authentication of a password can be performed using the set password. All the buttons of the portable device can be used to set a password, instead of text or number buttons. As a combination of letters and/or numbers is a password for a mobile phone, PDA, or PC, a combination of operation buttons, such as a reproduction button, a menu button, up, down, left, and right buttons, and a stop button, may be used to set a password. In addition, the number of combinations of symbols may be increased by distinguishing a long press operation from a short press operation of the buttons.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of setting a password in a portable device having a small number of buttons, the method comprising:
determining whether one of the buttons, other than a button corresponding to a number or a letter, is pressed within a predetermined time;
displaying a symbol corresponding to the pressed button, each time a button is pressed within the predetermined time; and
setting displayed symbols corresponding to the pressed buttons as a password required for using the portable device.

2. A computer-readable recording medium having embodied thereon a computer program to execute a method comprising:
determining whether a button of a portable device, other than a button corresponding to a number or letter, is pressed within a predetermined time;
displaying a symbol corresponding to the pressed button, each time a button is pressed within the predetermined time; and
setting displayed symbols corresponding to the pressed buttons as a password required for using the portable device.

3. A method of setting a password in a portable device having a small number of buttons, the method comprising:
determining whether a one of the buttons, other than a button corresponding to a number or a letter, is pressed within a predetermined time;
determining whether the pressed button is valid for use in a password;
displaying a symbol corresponding to the pressed button each time a valid button is pressed;
determining whether the pressed button represents an end of an input of symbols, if the pressed button is invalid for use in the password; and
setting displayed symbols corresponding to the valid pressed buttons that do not represent an end of an input of symbols as a password required for using the portable device, if the pressed button represents the end of the input of symbols.

4. The method of claim 3, further comprising determining whether the portable device is in a password setting mode prior to determining whether one of the buttons is pressed.

5. The method of claim 3, further comprising counting the number of displayed symbols after displaying the symbol corresponding to the pressed button.

6. The method of claim 5, further comprising determining whether the number of displayed symbols is less than a predetermined value, when one of the buttons has been pressed within the predetermined time; and
setting the displayed symbols as a password only if the number of displayed symbols is equal to or greater than the predetermined value.

7. The method of claim 3, further comprising:
determining whether the password is requested to be input again;
determining whether previously displayed symbols match currently displayed symbols, if the password is not requested to be input again; and
displaying a setting error message indicating that setting of the password has failed, if the previously displayed symbols do not match the currently displayed symbols.

8. The method of claim 3, wherein each of the buttons are distinguishable into two separate symbols based on different pressing durations of the buttons.

9. A computer-readable recording medium having embodied thereon a computer program to execute a method, the method comprising:
determining whether a button of a portable device, other than a button corresponding to a number or a letter, is pressed within a predetermined time;
determining whether the pressed button is valid for use in a password;
displaying a symbol corresponding to each pressed button, if the pressed button is valid for use in the password;
determining whether the pressed button represents an end of an input of symbols, if the pressed button is invalid for use in the password; and
setting displayed symbols corresponding to all of the valid pressed buttons as a password required for using the portable device, when the pressed button represents the end of the input of the symbols.

10. A method of authenticating a password in a portable device having a small number of buttons, the method comprising:
determining whether a one of the buttons, other than a button corresponding to a number or a letter, is pressed within a predetermined time;
displaying a symbol corresponding to the pressed button, each time a valid button is pressed;
determining whether the displayed symbols match a previously set password, when one of the pressed buttons represents an end of an input of symbols; and
authenticating the password required for using the portable device if the displayed symbols match the previously set password.

11. A computer-readable recording medium having embodied thereon a computer program to execute a method comprising:
determining whether a button of a portable device, other than a button corresponding to a number or a letter, is pressed within a predetermined time;
displaying a symbol corresponding to each pressed button;
determining whether the displayed symbols match a previously set password, if a button representing an end of an input of symbols is pressed; and
authenticating the password required for using the portable device if the displayed symbols match the previously set password.

12. A method of authenticating a password in a portable device having a small number of buttons, the method comprising:
determining whether a one of the buttons, other than a button corresponding to a number or a letter, is pressed within a predetermined time;
determining whether the pressed button is valid for use in the password;
displaying a symbol corresponding to each pressed button, if the pressed button is valid for use in the password;
determining whether the pressed button represents an end of an input of symbols, if the pressed button is invalid for use in the password;
determining whether displayed symbols match a previously set password, if the pressed button represents the end of the input of symbols; and
authenticating the password required for using the portable device if the displayed symbols match the previously set password.

13. The method of claim 12, further comprising determining whether the portable device is in a password authentication mode prior to determining whether one of the buttons is pressed.

14. The method of claim 12, further comprising counting the number of displayed symbols after displaying the symbol corresponding to each pressed button.

15. The method of claim 14, further comprising determining whether the number of displayed symbols is less than a predetermined value; and
determining whether the displayed symbols match the previously set password only if the number of displayed symbols is equal to or greater than the predetermined value.

16. The method of claim 12, further comprising:
displaying an authentication error message indicating that authentication of the password has failed, if the displayed symbols do not match the previously set password;
determining whether the number of repeated attempts to authenticate passwords has exceeded a predetermined number; and
turning off the portable device if the number of the repeated authentications of the passwords exceeds the predetermined number.

17. The method of claim 12, wherein each of the buttons are distinguishable into two separate symbols based on different pressing durations of the button.

18. A computer-readable recording medium having embodied thereon a computer program for executing a method comprising:
determining whether a button of the portable device, other than a button corresponding to a number or a letter, is pressed within a predetermined time;
determining whether each pressed button is valid for use in a password;
displaying a symbol corresponding to each pressed button for each pressed button that is valid for use in the password;
determining whether one of the pressed buttons represents an end of an input of symbols, if the one of the pressed buttons is invalid for use in the password;
determining whether the displayed symbols matched a previously set password, if the one of the pressed buttons represents an end of the input of the symbols; and
authenticating the password required for using the portable device if the displayed symbols match a previously set password.

19. A portable device, comprising:
a plurality of buttons comprising a subset of buttons not corresponding to a number or a letter;
a display to display symbols corresponding to the subset of buttons;
a controller to receive input corresponding to a first sequence of presses of the subset of buttons, to display the symbols corresponding to the first sequence, to determine that a password has been entered based on the first sequence, and to verify that the password was entered correctly; and
a storage unit to store a sequence of symbols and index information mapping buttons to corresponding symbols;
wherein each press included in the sequence corresponds to a button that was pressed and a duration of the pressing of the button.

20. The portable device of claim 19, wherein:
the controller determines that the password was entered correctly if a second sequence is input matching the first sequence; and
the controller stores the sequence of symbols corresponding to the first sequence in the storage unit as a password.

21. The portable device of claim 19, wherein the controller determines that the password was entered correctly if a sequence of symbols corresponding to the first sequence matches the sequence of symbols stored in the storage unit.

22. The portable device of claim 20, wherein the controller determines that the password was entered incorrectly if a second sequence is input that does not match the first sequence.

23. The portable device of claim 21, wherein the controller determines that the password was entered incorrectly if a sequence of symbols corresponding to the first sequence does not match the sequence of symbols stored in the storage unit.

24. The portable device of claim 23, wherein the controller deactivates the portable device after a predetermined number of attempts to match the sequence of symbols corresponding to the first sequence with the sequence of symbols stored in the storage unit.

25. The portable device of claim 19, wherein the controller counts the number of symbols in the sequence of symbols corresponding to the first sequence, and controls the display unit to display an error message if the number of symbols is less than a predetermined amount.

26. The portable device of claim 19, wherein the controller determines the end of the first sequence based on the pressing of a button corresponding to an end of input button.

27. The portable device of claim 19, wherein the controller determines that a press of a button is part of the first sequence if the button is pressed within a predetermined time.

28. A method of setting or authenticating a password using a plurality of buttons on a device that do not correspond to numbers or letters, the method comprising:
receiving input corresponding to a sequence of presses of the plurality of buttons;
interpreting the input as a first sequence of symbols, each symbol corresponding to a particular button that was pressed and a duration of the pressing of the button;
verifying the first sequence of symbols; and
setting or authenticating the password based on an operating mode of the portable device.

29. The method of claim 28, wherein:
the operating mode is a password setting mode; and
the first sequence of symbols is verified by matching the first sequence of symbols with a second sequence of symbols corresponding to another received sequence of presses of the plurality of buttons.

30. The method of claim 29, wherein the first sequence of symbols is set as the password.

31. The method of claim 28, wherein:
the operating mode is a password authentication mode; and
the first sequence of symbols is verified by matching the first sequence of symbols with a stored sequence of symbols corresponding to the password.

32. The method of claim 31, further comprising:
deactivating the portable device if a number of failed attempts to verify a received sequence of symbols is equal to a predetermined number.

33. The method of claim 28, wherein the input is interpreted based on index information matching a press of a button and a length of time the button was pressed to a corresponding symbol.

34. A computer readable medium comprising instructions that, when executed by a portable device, cause the portable device to perform the method of claim 28.

35. The method of claim 28, further comprising:
counting the number of symbols in the first sequence; and
displaying an error message if the number of symbols in the first sequence is less than a predetermined amount.

36. The method of claim 28, further comprising:
determining the end of the first sequence based on the pressing of a button corresponding to an end of input button.

37. The method of claim 28, further comprising:
determining that a press of a button is part of the first sequence if the button is pressed within a predetermined time.
